(19) United States
(12) Patent Application Publication
(10) Pub. No.: US 2024/0100638 A1
(43) Pub. Date: Mar. 28, 2024

(54) INSTALLATION/REMOVAL DEVICE FOR ONE OR MORE ROTOR BLOCKS OF A TURBOCHARGER ASSEMBLY, AND METHOD

(71) Applicant: ABB SWITZERLAND LTD., Baden (CN)

(72) Inventors: Bernd ALBIEZ, Rickenbach (DE); Christoph MATHEY, Fislisbach (CH)

(21) Appl. No.: 17/769,084

(22) PCT Filed: Oct. 8, 2020
(86) PCT No.: PCT/EP2020/078298

§ 371 Date: Apr. 14, 2022

(30) Foreign Application Priority Data
Oct. 16, 2019 (EP) 19203608.5

(51) Int. Cl. B23P 19/04; F01D 25/28

(52) U.S. Cl. CPC B23P 19/042; F01D 25/285; F05D 2220/40; F05D 2230/644; F05D 2230/68

(57) ABSTRACT

Disclosed is an installation/removal device for translationally moving one or more rotor blocks in a housing of a single- or multi-stage turbocharger assembly. The device comprises a support element having first and second guide rails. Furthermore, the device comprises a movement device having a first slide, which is movably arranged on the first guide rails, and a second slide which is movably arranged on the second guide rails. The movement device comprises a spindle, which is rotatably mounted in the support element, and a connection element which is connected to the spindle, to the first slide and/or to the second slide. The device comprises a fastening device having a first fastening structure for fastening a first rotor block and a second fastening structure for fastening a second rotor block. The first fastening structure is connected to the first slide, and the second fastening structure is connected to the second slide.

### TECHNICAL FIELD

The invention relates to the field of exhaust turbochargers for pressure-charged internal combustion engines, in particular multi-stage exhaust turbochargers. In particular, the invention relates to an installation/removal device for one or more rotor blocks of a turbocharger assembly, and to a method in connection with the installation/removal of one or more rotor blocks.

### TECHNICAL BACKGROUND

Exhaust turbochargers are used for pressure-charging large internal combustion engines. These drive ships or large power generators, for example.

In order to maintain the exhaust turbocharger at intervals of several thousand working hours, the rotating parts must be removed from the housing. For this purpose, in the case of conventional exhaust turbochargers, the multi-part housings are removed and the rotor is then lifted out of the housing in the axial direction with the aid of a crane. Specifically, in order to remove an exhaust turbocharger, the compressor housing is generally removed in order to be able to attach a boom of the crane above the center of gravity of the rotor block.

In addition to the rotating parts of the shaft and the turbine and compressor wheels connected to the shaft, the rotor block of an exhaust turbocharger also comprises the bearing parts, that is to say axial and radial bearings, and internal bearing-housing parts. This rotor block is also referred to as a cartridge. In the case of servicing, it is possible to completely replace a cartridge of an exhaust turbocharger. This reduces the outage time of the exhaust turbocharger and hence of the internal combustion engine pressure-charged by means of the exhaust turbocharger. The effort involved in removing and reinserting the cartridge can be further reduced if as few housing parts as possible have to be removed. For example, it is desirable not to have to dismantle the outer compressor housing, which is firmly integrated with its large air outlet connection piece into the pipe system of the internal combustion engine, or indeed the entire turbine housing during the maintenance work. Particularly in the case of multi-stage turbocharger assemblies which consist of a plurality of separate turbocharger subassemblies, the servicing and maintenance work is particularly time-consuming and cost-intensive and involves relatively long downtimes/outage times.

Accordingly, there is a need to provide an improved installation/removal device and methods by means of which the maintenance/servicing times and thus the downtimes/outage times can be reduced.

### SUMMARY OF THE INVENTION

To solve the abovementioned problem, an installation/removal device, a method for simultaneously inserting at least two rotor blocks, a method for pulling out/inserting one or more rotor blocks and a method for moving one or more rotor blocks are provided in accordance with the independent claims. Further aspects, advantages and features of the present invention can be found in the dependent patent claims, the description and the accompanying figures.

According to one aspect of the invention, an installation/removal device is provided for translationally moving one or more rotor blocks in a housing of a single- and/or multi-stage turbocharger assembly. The installation/removal device comprises a support element having first guide rails, which are arranged on a first longitudinal side of the support element, and second guide rails, which are arranged on a second longitudinal side of the support element. In addition, the installation/removal device comprises a movement device having a first slide, which is arranged so as to be movable on the first guide rails, and a second slide, which is arranged so as to be movable on the second guide rails. Furthermore, the movement device comprises a spindle, which is rotatably mounted in the support element. In addition, the movement device comprises a connection element, which is connected to the spindle, to the first slide and/or to the second slide. The connection element is configured to convert a rotary movement of the spindle into a translational movement of the first slide and/or the second slide. Moreover, the installation/removal device comprises a fastening device, which has a first fastening structure for fastening a first rotor block and a second fastening structure for fastening a second rotor block. The first fastening structure is connected to the first slide, and the second fastening structure is connected to the second slide.

Thus, an improved installation/removal device is advantageously provided by means of which the maintenance/servicing times and thus the downtimes/outage times can be reduced. In particular, according to the present disclosure, the installation/removal device enables two rotor blocks, for example a first rotor block of a high-pressure stage and a second rotor block of a low-pressure stage, to be installed/removed simultaneously. Furthermore, with the installation/removal device described herein, either the first rotor block or the second rotor block can be moved into or pulled out of the housing of the single- and/or multi-stage turbocharger assembly.

According to a further aspect of the invention, a method for simultaneously inserting at least two rotor blocks into a housing of a multi-stage turbocharger assembly by means of an installation/removal device is provided. In particular, the installation/removal device is an installation/removal device according to one of the embodiments described herein. The method comprises installing in each case at least one guide element, e.g. a guide rod, per rotor block of the turbocharger assembly. The at least one guide element is arranged and configured to guide the rotor blocks along the axis of rotation of the rotor blocks as they are moved in. In addition, the method comprises connecting the at least two rotor blocks by means of a rigid fastening element. Furthermore, the method comprises fastening a first fastening structure of an installation/removal device to a first rotor block and fastening a second fastening structure of an installation/removal device to a second rotor block. In addition, the method comprises moving the at least two rotor blocks into the housing of the multi-stage turbocharger assembly.

According to a further aspect of the invention, a method for pulling out/inserting one or more rotor blocks from/into a housing of a single- and/or multi-stage turbocharger assembly by means of an installation/removal device is provided. In particular, the installation/removal device is an installation/removal device according to one of the embodiments described herein. The method comprises installing in each case at least one guide element per rotor block of the turbocharger assembly. The guide elements are arranged and configured to guide the rotor blocks along the axis of rotation of the rotor blocks as they are moved out. In addition, the method comprises fastening a support element of the installation/removal device to the housing of the single- and/or multi-stage turbocharger assembly. Furthermore, the method comprises fastening a first fastening structure of the installation/removal device to a first rotor block. Alternatively or additionally, the method comprises fastening a second fastening structure of the installation/removal device to a second rotor block. Moreover, the method comprises pulling out the first rotor block and/or the second rotor block by moving the first fastening structure and/or the second fastening structure relative to and along the support element.

According to a further aspect of the invention, a method for moving one or more rotor blocks is provided. The method comprises fastening the one or more rotor blocks to a rigid fastening element, in particular a rigid bracket-like fastening element. The method further comprises moving the one or more rotor blocks while the one or more rotor blocks are fastened to the fastening element.

Thus, methods are advantageously provided by means of which the time required for maintenance/servicing work on turbocharger assemblies can be reduced, thus making it possible to reduce downtimes/outage times.

### BRIEF DESCRIPTION OF THE FIGURES

The invention will be explained below with reference to exemplary embodiments, which are illustrated in the figures and from which further advantages and modifications can be derived. Here:

FIG. 1 shows a schematic front view of an air inlet side of a turbocharger assembly having an installation/removal device according to embodiments described herein;

FIG. 2 shows a sectional view along the line A-A in FIG. 1;

FIG. 3 shows a schematic side view of a turbocharger assembly having an installation/removal device according to embodiments described herein;

FIG. 4 shows a schematic front view of an air inlet side of a multi-stage turbocharger assembly having an installation/removal device according to embodiments described herein; and

FIG. 5 shows a schematic perspective view of a multi-stage turbocharger assembly having an installation/removal device according to embodiments described herein;

### DETAILED DESCRIPTION OF THE FIGURES

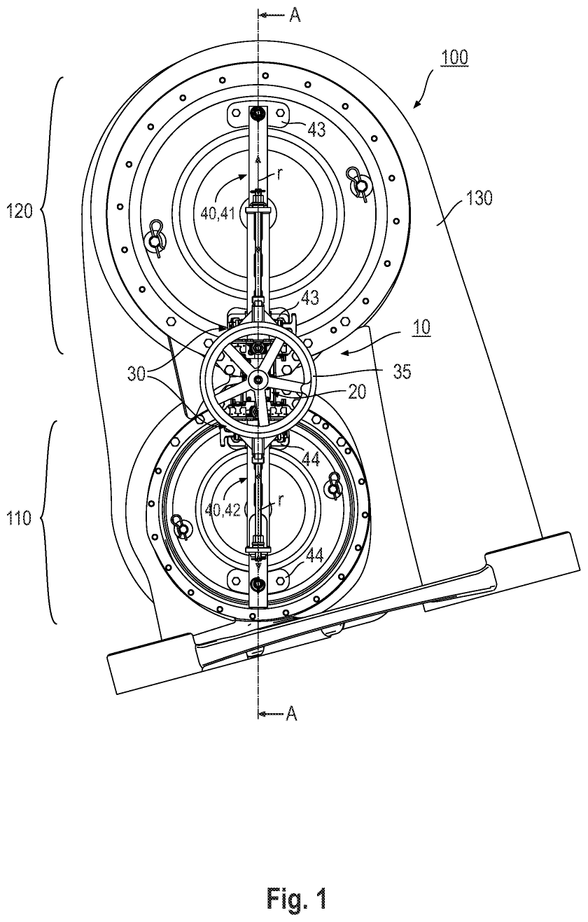

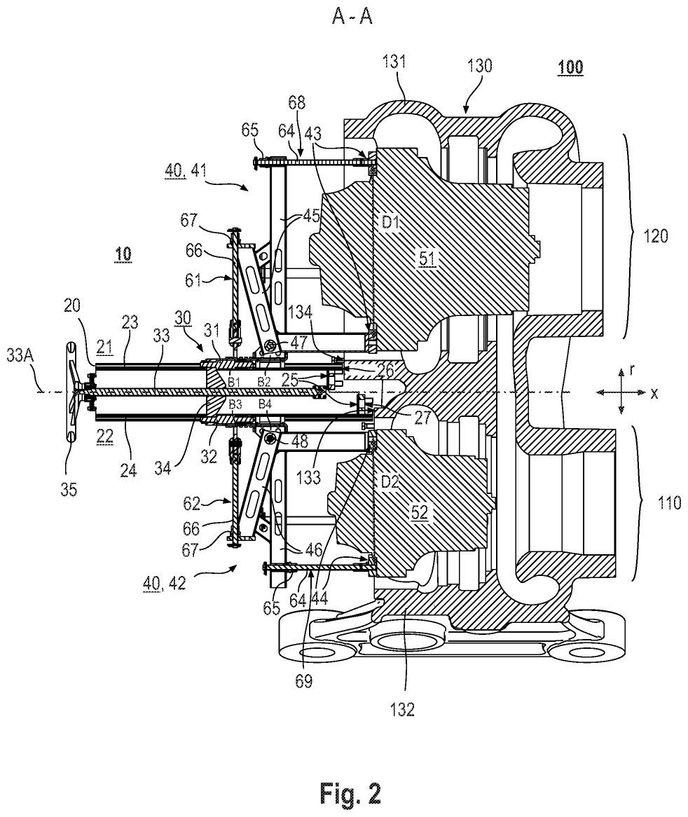

An installation/removal device 10 according to the present disclosure is described with reference to FIGS. 1 and 2. The installation/removal device 10 is suitable for translationally moving one or more rotor blocks in a housing 130 of a single- and/or multi-stage turbocharger assembly 100. The term “translational movement” is to be understood as meaning movement along an axis of rotation of a rotor contained in the rotor block, in particular along the shaft axis of the rotor contained in the rotor block.

FIG. 1 shows a schematic front view of an air inlet side of a turbocharger assembly having an installation/removal device according to embodiments described herein, and FIG. 2 shows a sectional view along the line A-A in FIG. 1.

According to one embodiment, which can be combined with other embodiments described herein, the installation/removal device 10 comprises a support element 20, a movement device 30 and a fastening device 40.

The support element 20 comprises first guide rails 23, which are arranged on a first longitudinal side 21 of the support element 20. Furthermore, the support element 20 comprises second guide rails 24, which are arranged on a second longitudinal side 22 of the support element. Typically, the first longitudinal side 21 and the second longitudinal side 22 are situated opposite one another, as illustrated by way of example in FIG. 2.

The movement device 30 comprises a first slide 31, which is arranged so as to be movable on the first guide rails 23. Furthermore, the movement device 30 comprises a second slide 32, which is arranged so as to be movable on the second guide rails 24. In addition, the movement device 30 comprises a spindle 33, which is rotatably mounted in the support element 20. As illustrated by way of example in FIGS. 1 and 2, the spindle 33 can be connected to a spindle wheel, in particular to a hand wheel 35, in order to rotate the spindle. Alternatively, it is also possible for the spindle to be connected to a motor. Accordingly, the spindle can be rotated manually or mechanically.

In addition, the movement device 30 comprises a connection element 34, which is connected to the spindle 32, to the first slide 31 and/or to the second slide 32. The connection element is configured to convert a rotary movement of the spindle into a translational movement of the first slide 31 and/or the second slide 32. In particular, the connection element has a bore with an internal thread which fits onto the external thread of the spindle. Typically, the first slide 31 and the second slide 32 are releasably connected to the connection element 34. In other words, the first slide 31 and/or the second slide 32 can be decoupled from the connection element 34, thus enabling the first slide 31 or the second slide 32 to be moved separately from one another by a rotary movement of the spindle. Thus, if required, a first rotor block 51 or a second rotor block 52 can be moved into or pulled out of the housing of the single- and/or multi-stage turbocharger assembly independently of one another.

The fastening device 40 comprises a first fastening structure 41 for fastening a first rotor block 51 and a second fastening structure 42 for fastening a second rotor block 52. The first fastening structure 41 is connected to the first slide 31. The second fastening structure 42 is connected to the second slide 32. In this context, it should be pointed out that, in principle, it is also possible to provide more than two fastening structures (embodiment not illustrated in the figures). For example, the installation/removal device can be expanded by a third, fourth, etc., fastening structure in order to provide an installation/removal device for a corresponding number of rotor blocks.

According to one embodiment, which can be combined with other embodiments described herein, the support element 20 comprises, on a fastening side of the support element, fastening elements 25 for fastening to the housing 130 of the single- and/or multi-stage turbocharger assembly 100. In particular, the fastening elements 25 are arranged and configured to fasten the support element 20 to a housing region which is arranged between a high-pressure stage 110 and a low-pressure stage 120 of the housing 130.

In this context, it should be noted that the support element 20 is configured in such a way that when it is fastened to the housing 130 of the single- and/or multi-stage turbocharger assembly 100, it assumes the function of a cantilever support. The support element may also be referred to as a support frame. A cantilever support (also known in the literature as a cantilever beam or cantilever arm) is generally a horizontal beam which is supported at one end and carries a load. The cantilever beam has a single bearing support (in this case the fastening of the support element 20 to the housing 130). The cantilever beam can generally be subjected to shear, bending and torsional stress, wherein the bearing support fixes all six degrees of freedom (forces and moments).

According to one embodiment, which can be combined with other embodiments described herein, a first fastening end 26 of the support element 20 can be connected to a compressor-side flange 134 of a housing 131 of the low-pressure stage 120 of the housing 130 of a single- and/or multi-stage turbocharger assembly. A second fastening end 27 of the support element 20 can be connected to a compressor-side flange 133 of a housing 132 of the high-pressure stage 110 of the housing 130 of the single- and/or multi-stage turbocharger assembly. In this context, it should be pointed out that the multi-stage housing 130 can be of one-part, i.e. integral, or multi-part design. In other words, the housing 131 of the low-pressure stage 120 and the housing 132 of the high-pressure stage 110 can be of integral design or can consist of separate housing parts and/or multi-part housing units.

According to one embodiment, which can be combined with other embodiments described herein, the first fastening structure 41 comprises two first fastening elements 43, which are spaced apart in the radial direction r, in particular in the radial direction with respect to the axis of rotation of the first rotor block 51, and are situated opposite one another, for fastening the first fastening structure 41 to the first rotor block 51, as illustrated by way of example in FIGS. 1-3.

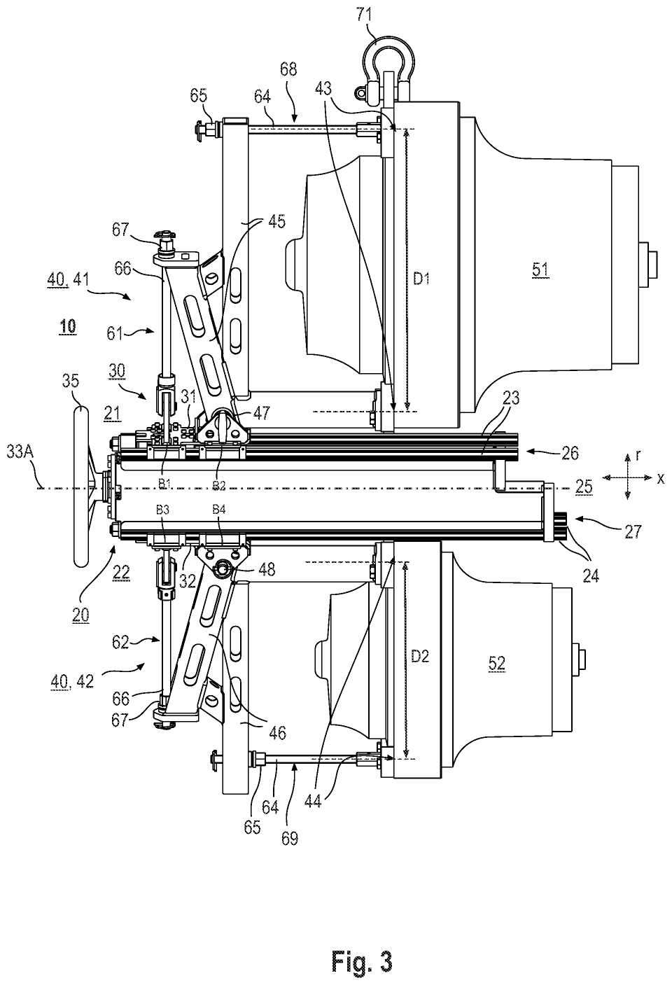

According to one embodiment, which can be combined with other embodiments described herein, the first fastening elements 43 are connected to a first tilting bolt 47 and a first radial fastening 61 via a first profiled rod structure 45. The first tilting bolt 47 and the first radial fastening 61 are connected to the first slide 31, as illustrated by way of example in FIGS. 2 and 3. In particular, the first tilting bolt 47 and the first radial fastening 61 are connected to the first slide 31 at two fastening points B1, B2, which are spaced apart axially from one another in the direction of the spindle axis 33A.

According to one embodiment, which can be combined with other embodiments described herein, the second fastening structure 42 comprises two second fastening elements 44, which are spaced apart in the radial direction r, in particular in the radial direction with respect to the axis of rotation of the second rotor block 52, and are situated opposite one another, for fastening the second fastening structure 42 to the second rotor block 52, as illustrated by way of example in FIGS. 1-3.

According to one embodiment, which can be combined with other embodiments described herein, the second fastening elements 44 are connected to a second tilting bolt 48 and a second radial fastening 62 via a second profiled rod structure 46. The second tilting bolt 48 and the second radial fastening 62 are connected to the second slide 32, as illustrated by way of example in FIGS. 2 and 3. In particular, the second tilting bolt 48 and the second radial fastening 62 are connected to the second slide 32 at two fastening points B3, B4, which are spaced apart axially from one another in the direction of the spindle axis 33A.

The first profiled bar structure 45 and the second profiled bar structure 46 serve to absorb and transmit forces to the support element 20.

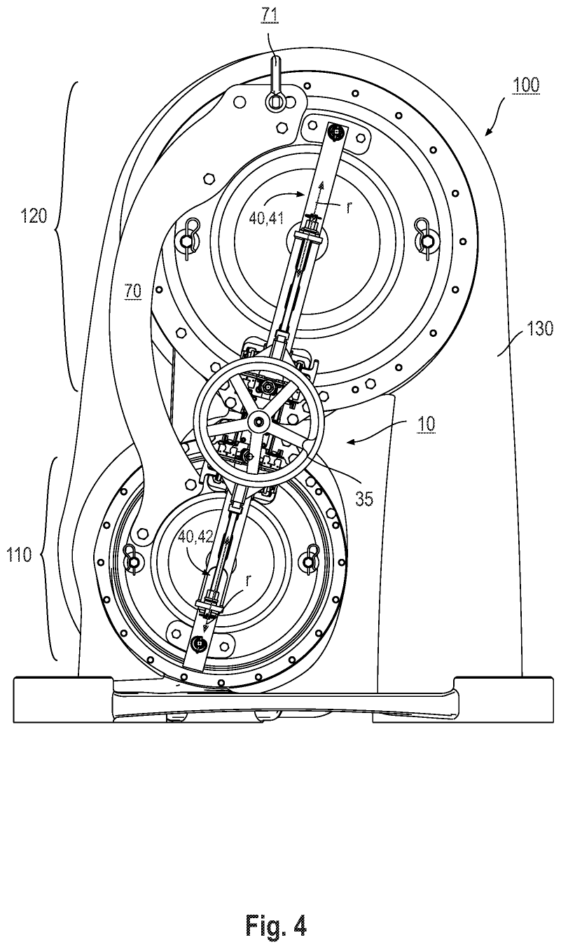

According to one embodiment, which can be combined with other embodiments described herein, a spacing D1 between the first fastening elements 43 is greater than or equal to a spacing D2 between the second fastening elements 44 (D1≥D2). The spacings D1 and D2 are shown in FIGS. 3 and 4.

According to one embodiment, which can be combined with other embodiments described herein, the connection element 34 is connected to the first slide 31 and/or to the second slide 32 via a releasable connection, in particular one or more screwed connections.

According to one embodiment, which can be combined with other embodiments described herein, at least one of the first fastening elements 43 comprises means for adjusting the alignment of the first fastening structure 41 with respect to a first rotor block 51, which is to be fastened to the first fastening structure 41. In particular, a first axial fastening 68 comprises means for adjusting the alignment of the first fastening structure 41 with respect to a first rotor block 51, which is to be fastened to the first fastening structure 41. For example, these means can be of mechanical, hydraulic or pneumatic design. By way of example, a mechanical means with a threaded rod 64 and a nut 65 is illustrated in FIG. 2.

According to one embodiment, which can be combined with other embodiments described herein, at least one of the second fastening elements 44 comprises means for adjusting the alignment of the second fastening structure 42 with respect to a second rotor block 52, which is to be fastened to the second fastening structure 42. In particular, a second axial fastening 69 comprises means for adjusting the alignment of the second fastening structure 42 with respect to a second rotor block 52, which is to be fastened to the second fastening structure 42. For example, these means can be of mechanical, hydraulic or pneumatic design. By way of example, a mechanical means with a threaded rod 64 and a nut 65 is illustrated in FIG. 2.

In the present application, an “axial fastening” can be understood to mean a fastening which is used for fastening in the axial direction. The axial direction x is illustrated in FIGS. 2 and 3. Typically, the axial direction x is parallel to the spindle axis 33A and/or parallel to the axis of rotation of the first rotor block 51 and/or parallel to the axis of rotation of the second rotor block 52.

According to one embodiment, which can be combined with other embodiments described herein, the first radial fastening 61 comprises means for adjusting the alignment of the first fastening structure 41 with respect to the support element 20. In particular, these means are of mechanical, hydraulic or pneumatic design and are configured in such a way that the angular position of the first fastening structure 41 about the axis of the first tilting bolt 47 can be adjusted. For example, the mechanical means for adjusting the alignment of the first fastening structure 41 can comprise a threaded rod 66 and a nut 67, which are configured in such a way that the angular position of the first fastening structure 41 about the axis of the first tilting bolt 47 can be adjusted by means of the nut 67 and the threaded rod 66.

According to one embodiment, which can be combined with other embodiments described herein, the second radial fastening 62 comprises means for adjusting the alignment of the second fastening structure 42 with respect to the support element 20. In particular, these means are of mechanical, hydraulic or pneumatic design and are configured in such a way that the angular position of the second fastening structure 42 about the axis of the second tilting bolt 48 can be adjusted. For example, the mechanical means for adjusting the alignment of the second fastening structure 42 can comprise a threaded rod 66 and a nut 67, which are configured in such a way that the angular position of the second fastening structure 42 about the axis of the second tilting bolt 48 can be adjusted by means of the nut 67 and the threaded rod 66.

With respect to the means, provided on the axial fastenings 68, 69, for adjusting the alignment of the fastening structures 41, 42 with respect to the rotor blocks 51, 52 to be fastened, and the means, provided on the radial fastenings 61, 62, for adjusting the alignment of the fastening structures 41, 42 with respect to the support element 20, it should be noted that a radial adjustment of the spacing of the rotor blocks 51, 52 can be performed by superimposing the two adjustment possibilities. It should furthermore be noted that the radial fastenings 61, 62 extend in the radial direction from the spindle axis 33A, as can be seen by way of example from FIG. 2.

According to one embodiment, which can be combined with other embodiments described herein, the installation/removal device comprises an additional rigid fastening element 70 for rigidly connecting the first rotor block 51 and the second rotor block 52. Typically, the rigid fastening element 70 is of arcuate design, as illustrated by way of example in FIG. 4. Furthermore, the rigid fastening element 70 can have a holder 71, e.g. a hook receptacle, for fastening to a crane. The holder 71 is illustrated in FIGS. 3 and 4.

In the following, methods according to the invention are described for the installation/removal of one or more rotor blocks of a turbocharger assembly, in particular with a housing of a single- and/or multi-stage turbocharger assembly (i.e. a turbocharger assembly for one or more low-pressure stages and one or more high-pressure stages).

The methods described below can be carried out in combination with the embodiments of the installation/removal device described herein. In this context, it is pointed out, however, that the methods described below do not necessarily have to be carried out with the specific embodiments of the installation/removal device described herein, but can also be carried out independently thereof.

According to one aspect of the invention, a method for simultaneously inserting at least two rotor blocks into a housing 130 of a multi-stage turbocharger assembly 100 by means of an installation/removal device is provided. In particular, the installation/removal device is an installation/removal device 10 according to one of the embodiments described herein. The method comprises installing in each case at least one guide element 80 per rotor block of the turbocharger assembly. The at least one guide element 80 is arranged and configured to guide the rotor blocks along the axis of rotation of the rotor blocks as they are moved in. Furthermore, the at least one guide element 80 is configured in such a way that it can bear the side load of the relevant rotor block, in particular in the event that the installation/removal device is installed at an angle to the vertical, as illustrated by way of example in FIGS. 1 and 4.

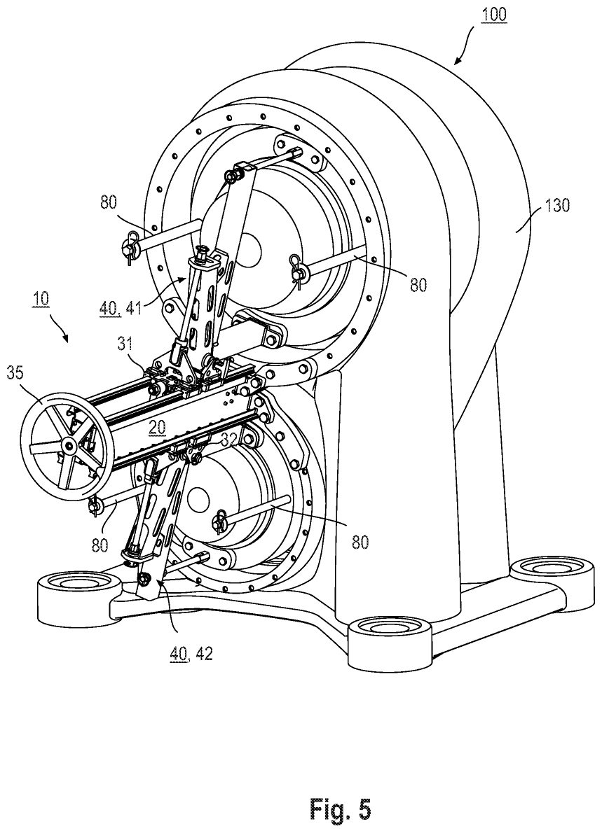

FIG. 5 shows by way of example four guide elements, in particular four guide rods, i.e. two per rotor block. In addition, the method comprises connecting the at least two rotor blocks by means of a rigid fastening element 70, as illustrated by way of example in FIG. 4. Furthermore, the method comprises fastening a first fastening structure 41 of an installation/removal device 10 to a first rotor block 51 and fastening a second fastening structure 42 of an installation/removal device 10 to a second rotor block 52. In addition, the method comprises moving the at least two rotor blocks into the housing 130 of the single- and/or multi-stage turbocharger assembly 100.

According to a further aspect of the invention, a method for pulling out/inserting one or more rotor blocks from/into a housing 130 of a single- and/or multi-stage turbocharger assembly 100 by means of an installation/removal device is provided. In particular, the installation/removal device is an installation/removal device 10 according to one of the embodiments described herein. The method comprises installing in each case at least one guide element 80 per rotor block of the turbocharger assembly. The guide elements are arranged and configured to guide the rotor blocks along the axis of rotation of the rotor blocks as they are moved out/moved in. In addition, the method comprises fastening a support element 120 of the installation/removal device to the housing 130 of the single- and/or multi-stage turbocharger assembly. Furthermore, the method comprises fastening a first fastening structure 41 of the installation/removal device to a first rotor block 51. Alternatively or additionally, the method comprises fastening a second fastening structure 42 of the installation/removal device to a second rotor block 52. Moreover, the method comprises pulling out/inserting the first rotor block 51 and/or the second rotor block 52 by moving the first fastening structure 41 and/or the second fastening structure 42 relative to and along the support element 20.

According to a further aspect of the invention, a method for moving one or more rotor blocks is provided. The method comprises fastening the one or more rotor blocks to a rigid fastening element 70, in particular a rigid bracket-like fastening element, as illustrated by way of example in FIG. 4. Furthermore, the method comprises moving the one or more rotor blocks, including an installation/removal device, in particular an installation/removal device according to embodiments described herein, while the one or more rotor blocks are being fastened to the fastening element. Typically, the installation/removal device is fastened to the one or more rotor blocks when moving the one or more rotor blocks. For example, moving the one or more rotor blocks may comprise moving by means of a crane, which may be fastened, for example, to the holder 71 of the rigid fastening element.

### LIST OF REFERENCE SIGNS

10 installation/removal device
20 support element
21 first side of the support element
22 second side of the support element
23 first guide rails
24 second guide rails
25 fastening elements of the support element
26 first fastening end of the support element
27 second fastening end of the support element
30 movement device
31 first slide
32 second slide
33 spindle
33A spindle axis
34 connection element
35 handwheel
40 fastening device
41 first fastening structure
42 second fastening structure
43 first fastening elements
44 second fastening elements
45 first profiled rod structure
46 second profiled rod structure
47 first tilting bolt
48 second tilting bolt
51 first rotor block
52 second rotor block
61 first radial fastening
62 second radial fastening
64, 66 threaded rod
65, 67 nut
68 first axial fastening
69 second axial fastening
70 rigid fastening element
71 holder for fastening to a crane
80 guide element
100 turbocharger assembly
110 high-pressure stage
120 low-pressure stage
130 housing of the single- and/or multi-stage turbocharger assembly
131 housing of the low-pressure stage
132 housing of the high-pressure stage
133 compressor-side flange of the housing of the high-pressure stage
134 compressor-side flange of the housing of the low-pressure stage
x axial direction
r radial direction
B1, B2, B3, B4 fastening points

1. An installation/removal device for translationally moving one or more rotor blocks in a housing of a single- or multi-stage turbocharger assembly, comprising:
a support element having first guide rails, which are arranged on a first longitudinal side of the support element, and second guide rails, which are arranged on a second longitudinal side of the support element;
a movement device having:
a first slide, which is arranged so as to be movable on the first guide rails, a second slide, which is arranged so as to be movable on the second guide rails,
a spindle, which is rotatably mounted in the support element, and
a connection element, which is connected to the spindle, to at least one of the first slide and the second slide, wherein the connection element is configured to convert a rotary movement of the spindle into a translational movement of at least one of the first slide and the second slide; and
a fastening device, which has a first fastening structure for fastening a first rotor block and a second fastening structure for fastening a second rotor block; wherein the first fastening structure is connected to the first slide, and the second fastening structure is connected to the second slide.

2. The installation/removal device as claimed in claim 1, wherein the support element comprises, on a fastening side of the support element, fastening elements for fastening to the housing of the single- or multi-stage turbocharger assembly.

3. The installation/removal device as claimed in claim 2, wherein a first fastening end of the support element can be connected to a compressor-side flange of a housing of the low-pressure stage of the housing of the single- or multi-stage turbocharger assembly, and wherein a second fastening end of the support element can be connected to a compressor-side flange of a housing of the high-pressure stage of the housing of the single- or multi-stage turbocharger assembly.

4. The installation/removal device as claimed in claim 1, wherein the first fastening structure comprises two first fastening elements, which are spaced apart in the radial direction (r) and are situated opposite one another, for fastening the first fastening structure to the first rotor block.

5. The installation/removal device as claimed in claim 4, wherein the first fastening elements are connected to a first tilting bolt and a first radial fastening via a first profiled rod structure, wherein the first tilting bolt and the first radial fastening are connected to the first slide.

6. The installation/removal device as claimed in claim 1, wherein the second fastening structure comprises two second fastening elements, which are spaced apart in the radial direction and are situated opposite one another, for fastening the second fastening structure to the second rotor block.

7. The installation/removal device as claimed in claim 6, wherein the second fastening elements are connected to a second tilting bolt and a second radial fastening via a second profiled rod structure, wherein the second tilting bolt and the second radial fastening are connected to the second slide at two fastening points (B3, B4), which are spaced apart axially from one another in the direction of the spindle axis (33A).

8. The installation/removal device as claimed in claim 4, wherein the second fastening structure comprises two second fastening elements, which are spaced apart in the radial direction and are situated opposite one another, for fastening the second fastening structure to the second rotor block, and wherein a spacing (D1) between the first fastening elements is greater than or equal to a spacing (D2) between the second fastening elements (D1≥D2).

9. The installation/removal device as claimed in claim 1, wherein the connection element is connected to at least one of the first slide and the second slide via a releasable connection.

10. The installation/removal device as claimed in claim 4, wherein at least one of the first fastening elements comprises means for adjusting the alignment of the first fastening structure with respect to a first rotor block, which is to be fastened to the first fastening structure.

11. The installation/removal device as claimed in claim 5, wherein at least one of the second fastening elements comprises means for adjusting the alignment of the second fastening structure with respect to a second rotor block, which is to be fastened to the second fastening structure.

12. The installation/removal device as claimed in claim 5, wherein the first radial fastening comprises means for adjusting the alignment of the first fastening structure with respect to the support element and are configured in such a way that the angular position of the first fastening structure about the axis of the first tilting bolt can be adjusted.

13. The installation/removal device as claimed in claim 7, wherein the second radial fastening comprises means for adjusting the alignment of the second fastening structure with respect to the support element and are configured in such a way that the angular position of the second fastening structure about the axis of the second tilting bolt can be adjusted.

14. The installation/removal device as claimed in claim 1, further comprising an additional rigid fastening element for rigidly connecting the first rotor block and the second rotor block.

15. A method for simultaneously inserting at least two rotor blocks into a housing of a multi-stage turbocharger assembly by means of an installation/removal device comprising
a support element having first guide rails, which are arranged on a first longitudinal side of the support element, and second guide rails, which are arranged on a second longitudinal side of the support element;
a movement device having:
a first slide, which is arranged so as to be movable on the first guide rails,
a second slide, which is arranged so as to be movable on the second guide rails,
a spindle, which is rotatably mounted in the support element, and
a connection element, which is connected to the spindle, to at least one of the first slide and the second slide, wherein the connection element is configured to convert a rotary movement of the spindle into a translational movement of at least one of the first slide and the second slide; and
a fastening device, which has a first fastening structure for fastening a first rotor block and a second fastening structure for fastening a second rotor block; wherein the first fastening structure is connected to the first slide, and the second fastening structure is connected to the second slide,
the method comprising:
installing in each case at least one guide element per rotor block of the turbocharger assembly, wherein the at least one guide element is arranged and configured to guide the rotor blocks along the axis of rotation of the rotor blocks as they are moved in,
connecting the at least two rotor blocks by means of a rigid fastening element;
fastening a first fastening structure of an installation/removal device to a first rotor block;
fastening a second fastening structure of an installation/removal device to a second rotor block;
moving the at least two rotor blocks into the housing of the multi-stage turbocharger assembly.

16. The method as claimed in claim 15, further comprising fastening a support element to the housing of the multi-stage turbocharger assembly, and wherein moving the at least two rotor blocks into the multi-stage housing comprises moving the first fastening structure and the second fastening structure relative to and along the support element.

17. A method for pulling out/inserting one or more rotor blocks from/into a housing of a single- or multi-stage turbocharger assembly by means of an installation/removal device comprising:
a support element having first guide rails, which are arranged on a first longitudinal side of the support element, and second guide rails, which are arranged on a second longitudinal side of the support element;
a movement device having:
a first slide, which is arranged so as to be movable on the first guide rails,
a second slide, which is arranged so as to be movable on the second guide rails,
a spindle, which is rotatably mounted in the support element, and
a connection element, which is connected to the spindle, to at least one of the first slide and the second slide, wherein the connection element is configured to convert a rotary movement of the spindle into a translational movement of at least one of the first slide and the second slide; and
a fastening device, which has a first fastening structure for fastening a first rotor block and a second fastening structure for fastening a second rotor block; wherein the first fastening structure is connected to the first slide, and the second fastening structure is connected to the second slide,
the method comprising:
installing in each case at least one guide element per rotor block of the turbocharger assembly, wherein the guide elements are arranged and configured to guide the rotor blocks along the axis of rotation of the rotor blocks as they are moved out/moved in,
fastening a support element of the installation/removal device to the housing of the single- or multi-stage turbocharger assembly;
fastening at least one of a first fastening structure of the installation/removal device to a first rotor block;
and a second fastening structure of the installation/removal device to a second rotor block;
pulling out/inserting at least one of the first rotor block and the second rotor block by moving at least one of the first fastening structure and the second fastening structure relative to and along the support element.

18. A method for moving one or more rotor blocks, comprising
fastening the one or more rotor blocks to a rigid fastening element; and
moving the one or more rotor blocks, including an installation/removal device, while the one or more rotor blocks are fastened to the fastening element, the installation/removal device comprising:
a support element having first guide rails, which are arranged on a first longitudinal side of the support element, and second guide rails, which are arranged on a second longitudinal side of the support element;
a movement device having:
a first slide, which is arranged so as to be movable on the first guide rails,
a second slide, which is arranged so as to be movable on the second guide rails,
a spindle, which is rotatably mounted in the support element, and
a connection element, which is connected to the spindle, to at least one of the first slide and the second slide, wherein the connection element is configured to convert a rotary movement of the spindle into a translational movement of at least one of the first slide and the second slide; and
a fastening device, which has a first fastening structure for fastening a first rotor block and a second fastening structure for fastening a second rotor block; wherein the first fastening structure is connected to the first slide, and the second fastening structure is connected to the second slide.

19. The installation/removal device as claimed in claim 5, wherein the second fastening elements are connected to a second tilting bolt and a second radial fastening via a second profiled rod structure, wherein the second tilting bolt and the second radial fastening are connected to the second slide, and wherein a spacing (D1) between the first fastening elements is greater than or equal to a spacing between the second fastening elements (D1≥D2).

20. The installation/removal device as claimed in claim 4, wherein the first fastening elements are connected to a first tilting bolt and a first radial fastening via a first profiled rod structure, wherein the first tilting bolt and the first radial fastening are connected to the first slide at two fastening points (B1, B2), which are spaced apart axially from one another in the direction of the spindle axis.
